(19) United States
(12) Patent Application Publication
(10) Pub. No.: US 2012/0294375 A1
(43) Pub. Date: Nov. 22, 2012

(54) Digital Broadcasting Receiver

(75) Inventor: Ryota TAKEUCHI, Daito-shi (JP)

(73) Assignee: Funai Electric Co., Ltd., Daito-shi (JP)

(21) Appl. No.: 13/474,248

(22) Filed: May 17, 2012

(30) Foreign Application Priority Data
May 18, 2011 (JP) 2011-111006

(51) Int. Cl. H04N 7/26

(52) U.S. Cl. 375/240.25; 375/E07.027

(57) ABSTRACT

A digital signal of a broadcast program received in an antenna is demodulated by a tuner unit, a Demux unit demultiplexes the digital signal into a video digital signal and an audio digital signal, a video decoding unit decodes the video digital signal, and a video output unit outputs video of the decoded video analog signal on a screen. On the other hand, an audio decoding unit decodes the audio digital signal, and an audio output unit outputs audio of the decoded audio analog signal to a speaker. A block noise detection unit performs detection of block noise contained in the video analog signal, at a latter stage of the video decoding unit. When the block noise is detected, an audio suppression unit lowers an output audio level through the audio output unit.

### BACKGROUND OF THE INVENTION

1. Field of the Invention

The present invention relates to a receiver that receives a digital broadcast signal, and in particular to a digital broadcasting receiver that applies an audio mute for suppressing an audio output with respect to the generation of block noise.

2. Background Art

As digital broadcast signals are disturbed with a change in a radio wave environment due to the worsening weather or the like, block noise is sometimes generated in digital broadcasting receivers that receive these signals.

In addition, even when errors are generated in digital broadcast signals (content) recorded on recorders, block noise may be generated at the time of reproducing the digital broadcast signals.

Such block noise is generated suddenly over a certain period of time as shown in FIG. 4, and thus video signals or audio signals are substantially missed in this period.

The block noise is noise by which a boundary line of an image is distinctly divided as in a mosaic in a digital image, and is noise causing a considerable disturbance of the image. For example, when the block noise is generated in video which is compressed and modulated in JPEG and MPEG formats, a compression algorithm called DCT (discrete cosine transformation) is used for compression of data in the JPEG and MPEG formats, and a screen is compressed by units of 8×8 pixels called a “block”. Therefore, when the compression ratio is made very high, luminance or color information is made uniform in a block unit, and thus an image becomes a mosaic due to disappearance of the gradation of the image.

In addition, the block noise is noise causing a harsh audio output like a large volume of abnormal sounds or popping suddenly over a certain period of time, and is noise providing an uncomfortable feeling to users watching digital broadcasts.

Because of such circumstances, the digital broadcasting receivers are required to cope with the generation of the block noise.

JP-A-2002-150723 discloses an invention in which in order to provide a signal processing device of an acoustic instrument capable of immediately following a change in an input signal without generating various defects, a forcible mute circuit is provided at a latter stage of a digital signal processor (DSP), which applies a mute by forcibly setting an output signal of the DSP to “0” in accordance with error detection data output from a multi-channel decoder (MCD) or a digital interface receiver (DIR).

JP-A-7-193767 discloses an invention of an audio mute device, connected to a microprocessor unit having a volume controlling output signal function for detecting the presence or absence of a synchronous signal to tune an output thereof, which applies an audio mute at least at any one of a case where there is no signal at the time of a television broadcast reception or an external input, and a case where there is an electric field intensity in which the video is seen but the synchronization is unstable due to noise.

JP-A-2001-245264 discloses an invention in which when receiving sensitivity of a program recorded on a magnetic tape by a video cassettes recorder is equal to or less than a reference value, a control unit of a CS tuner displays a message such as “receiving sensitivity is low, and image is recorded in a bad condition” on a screen of a television receiver, and when the contents of program data accumulated in an EPG data accumulation unit are retrieved at an arbitrary timing by a data retrieval unit and data having the same program in accumulated data are detected, the control unit displays data containing the date and time of rebroadcast of the program on the screen of the television receiver.

JP-A-2008-271100 discloses an invention for performing timer recording of a rebroadcast using information from an EPG information processing unit depending on error conditions of a reception error and a packet data error, and then performing a restoration process on error locations in a system control unit using data with fewer errors by comparing two pieces of recorded program data, thereby obtaining a recorded program in which defective reception due to rainfall or the like is restored only through the broadcast reception without using other means such as a network.

JP-A-2003-189253 discloses a disk reproducing device having a video output switching circuit that switches an output of a video signal reproduced from a disk to a video signal for interlace scanning and a video signal for progressive scanning, in which the video output switching circuit includes a first video amplifier which includes an amplifier circuit that amplifies the video signal for interlace scanning and a mute terminal, having a built-in filter for removing noise contained in the video signal for interlace scanning at a former stage of the amplifier circuit, for muting an output; a second video amplifier which includes an amplifier circuit that amplifies the video signal for progressive scanning and a mute terminal, having a built-in filter for removing noise contained in the video signal for progressive scanning at a former stage of the amplifier circuit, for muting an output; an output terminal to which outputs of the first video amplifier and the second video amplifier are commonly connected; and an inverter, a selection signal is input, as it is, to one mute terminal of the first video amplifier or the second video amplifier, and the selection signal is input through the inverter to the other mute terminal.

Although a technique for applying a mute on an audio output is proposed, a method for sufficiently effectively coping with block noise is not proposed in the digital broadcasting receiver.

For this reason, in the digital broadcasting receiver, the television receiver constituted by the digital broadcasting receiver, and the recorder constituted by the digital broadcasting receiver, even when the block noise is generated, it is not possible to provide a sufficiently comfortable viewing environment to a user.

### SUMMARY OF THE INVENTION

The invention is contrived in view of such circumstances, and an object thereof is to provide a digital broadcasting receiver allowing a user to watch a program without experiencing an uncomfortable feeling even when block noise is generated.

According to a first aspect of the invention, there is provided a digital broadcasting receiver including: a decoding means for decoding a received digital signal containing video and audio; an audio output means for performing an audio output process on the decoded audio signal; a detection means for detecting block noise contained in the signal, at a former stage or a latter stage of the decoding means; and an audio suppression means for lowering an output audio level through the audio output means, in accordance with the detection of the block noise in the detection means.

In the digital broadcasting receiver, the decoding means decodes the received digital signal containing video and audio, and the audio output means performs the audio output process on the decoded audio signal. On the other hand, when the detection means performs the detection of the block noise contained in the signal at the former stage or the latter stage of the decoding means to detect the block noise, the audio suppression means lowers the output audio level through the audio output means.

Thereby, the block noise is detected at the former stage or the latter stage of the decoding means suitable for detection, thereby allowing the audio output means for performing the audio output process on the decoded audio signal to appropriately perform a controlled audio mute for lowering the output audio level.

In addition, according to a second aspect of the invention, there is provided a digital broadcasting receiver including: a demultiplexing means for demultiplexing a received digital signal containing video and audio into a video digital signal and an audio digital signal; a video decoding means for decoding the video digital signal; a video output means for performing a video output process on the decoded video signal; an audio decoding means for decoding the audio digital signal; an audio output means for performing an audio output process on the decoded audio signal; a detection means for detecting block noise contained in the signal, at a former stage or a latter stage of the video decoding means, or a former stage or a latter stage of the audio decoding means; and an audio suppression means for lowering an output audio level through the audio output means, in accordance with the detection of the block noise in the detection means.

In the digital broadcasting receiver, the demultiplexing means demultiplexes the received digital signal containing video and audio into the video digital signal and the audio digital signal, the video decoding means decodes the video digital signal, and the video output means performs the video output process on the decoded video signal. On the other hand, the audio decoding means decodes the audio digital signal, and the audio output means performs the audio output process on the decoded audio signal. When the detection means performs the detection of the block noise contained in the signal at the former stage or the latter stage of the video decoding means, or the former stage or the latter stage of the audio decoding means, to detect the block noise, the audio suppression means lowers the output audio level through the audio output means.

Thereby, the detection of the block noise is performed on the video digital signal or the audio digital signal demultiplexed from the received digital signal, at the former stage or the latter stage of the decoding means suitable for the detection, thereby allowing the audio output means for performing the audio output process on the decoded audio signal to appropriately perform a control for lowering the output audio level.

The digital broadcasting receiver according to the invention may include a recording means for recording the received digital signal, and an information addition means for adding additional information indicating that the block noise is contained in the received digital signal recorded on the recording means, in accordance with the detection of the block noise in the detection means.

Thereby, it is possible to record the received digital signal on the recording means such as a HDD. Further, when the block noise is detected in the received digital signal, the information addition means adds the additional information indicating that the block noise is contained in the received digital signal recorded on the recording means. Therefore, when a user tries to reproduce and watch the received digital signal recorded on the recording means, it is possible to recognize the presence or absence of the block noise beforehand.

In the digital broadcasting receiver according to the invention, the received digital signal recorded on the recording means may be a broadcast program, and the digital broadcasting receiver may include a reservation means for retrieving rebroadcast of a broadcast program in which the block noise is detected by the detection means from broadcast schedule information, and performing a reservation process for recording the rebroadcast program on the recording means.

Thereby, when the block noise is contained in the broadcast program recorded on the recording means, the rebroadcasting program of the corresponding broadcast program is recorded on the recording means, and a user may reproduce and watch a broadcast program which does not contain the block noise.

The digital broadcasting receiver according to the invention may be configured, for example, as a video recorder, connected to a television receiver, in which video which is output by the video output means is displayed on a screen of the television receiver, and audio which is output by the audio output means is output from a speaker of the television receiver.

In addition, the digital broadcasting receiver according to the invention may be configured, for example, as a television receiver including a screen that displays video which is output by the video output means and a speaker that outputs audio which is output by the audio output means.

In the digital broadcasting receiver according to the invention, it is possible to apply a mute to an audio output by detecting block noise at an appropriate place of received signal processing, thereby allowing a user to watch a program without experiencing an uncomfortable feeling even when the block noise is generated.

Further, in the digital broadcasting receiver according to the invention, when a broadcast program is recorded on the recording means and the block noise is contained in the recorded broadcast program, a rebroadcast program of the corresponding broadcast program is recorded on the recording means, thereby allowing a user to reproduce and watch a broadcast program which does not contain the block noise.

### BRIEF DESCRIPTION OF THE DRAWINGS

FIG. 1 is a configuration diagram a digital broadcasting receiver according to an embodiment of the invention;

FIG. 2 is a diagram illustrating a reservation program list or an additional information list according to an embodiment of the invention;

FIG. 3 is a diagram illustrating a television receiver with a video recorder function according to an embodiment of the invention; and

FIG. 4 is a diagram for explaining block noise.

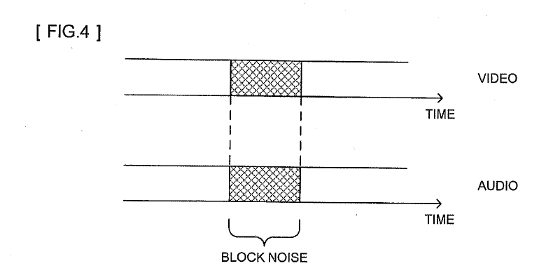

### DETAILED DESCRIPTION OF THE INVENTION

A digital broadcasting receiver according to the invention will be described in detail on the basis of an embodiment shown in the drawings.

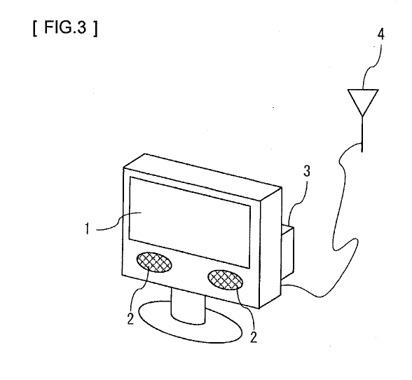

As shown in FIG. 3, the digital broadcasting receiver of the embodiment is configured as a television receiver with a video recorder function, and includes a screen 1 that displays video, a speaker 2 that outputs audio, and a processing unit 3 that performs an output process or a recording process on a digital signal received from an antenna 4.

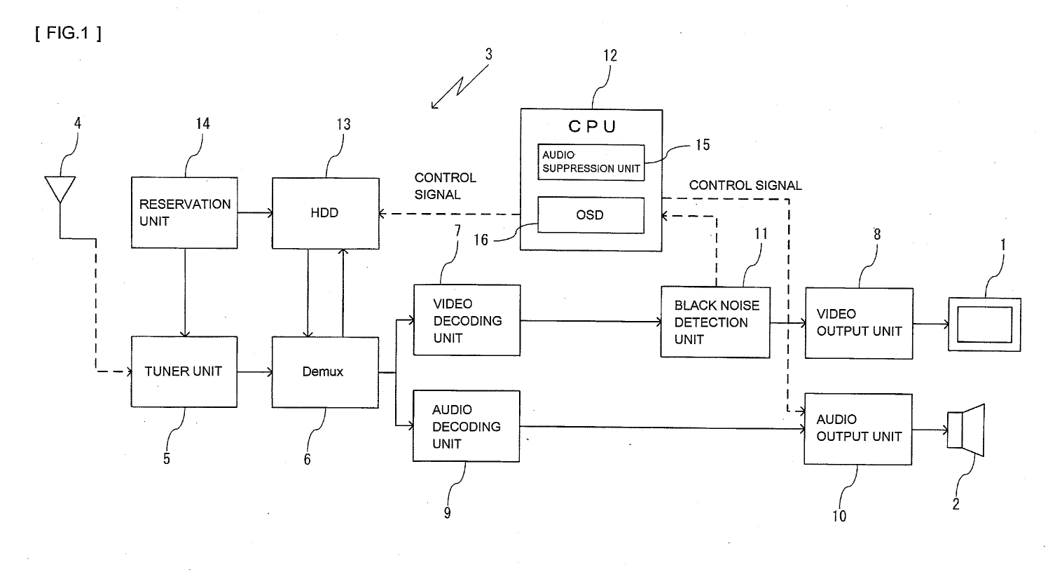

As shown in FIG. 1, the processing unit 3 includes a tuner unit 5 that receives a broadcast program of a digital signal from the antenna 4, a demultiplexing unit (Demux) 6 that demultiplexes the digital signal received in the tuner unit 5 into a video digital signal and an audio digital signal, a video decoding unit 7 that decodes the demultiplexed video digital signal to convert the decoded signal into a video analog signal, a video output unit 8 that performs a video output process on the decoded video analog signal to display the video on the screen 1, an audio decoding unit 9 that decodes the demultiplexed audio digital signal to convert the decoded signal into an audio analog signal, and an audio output unit 10 that performs an audio output process on the decoded audio analog signal to output the audio from the speaker 2.

Further, the processing unit 3 includes a block noise detection unit 11 that detects block noise contained in the video analog signal, between the video decoding unit 7 and the video output unit 8 (that is, in a latter stage of the video decoding unit 7), and also includes a control unit (CPU) 12 notified of the detection of the block noise from the detection unit 11, a recording unit (HDD) 13, such as a hard disk drive, which records the broadcast program of the digital signal received in the tuner unit 5, and a reservation unit 14 that performs a reservation process for recording a broadcast program on the recording unit (HDD) 13.

In addition, the control unit (CPU) 12 includes an audio suppression unit 15 that lowers an output audio level through the audio output unit 10 in accordance with the detection of the block noise in the detection unit 11, and an OSD processing unit (information addition unit) 16 that adds additional information “presence of block noise” indicating that the block noise is contained in the broadcast program recorded on the recording unit 13, and informs a user that disturbances exist in video and audio when a list of recorded broadcast programs is displayed on the screen 1.

Next, an operation of the above-mentioned television receiver with a video recorder function will be described.

<Operation as Television Receiver>

The digital signal of the broadcast program received in the antenna 4 is demodulated in the tuner unit 5, and the demodulated received digital signal is input to the demultiplexing unit (Demux) 6. More specifically, a radio-frequency digital signal (RF signal) received in the antenna 4 is demodulated in the tuner unit 5, and the demodulated intermediate-frequency digital signal (DIF signal) is transmitted to the demultiplexing unit 6.

The demultiplexing unit 6 demultiplexes the input digital signal into the video digital signal and the audio digital signal, outputs the video digital signal to the video decoding unit 7, and outputs the audio digital signal to the audio decoding unit 9.

The video decoding unit 7 decodes the video digital signal to output the video analog signal, and the audio decoding unit 9 decodes the audio digital signal to output the audio analog signal.

The video analog signal is output to the video output unit 8 through the block noise detection unit 11, and the video output unit 8 displays the video of the video analog signal on the screen 1.

The audio analog signal is output to the audio output unit 10 in synchronization with this, and the audio output unit 10 outputs the audio of the audio analog signal from the speaker 2.

Herein, when the block noise is detected from the video analog signal, the block noise detection unit 11 sends a noise detection signal to the control unit (CPU) 12 during the detection of the block noise. The audio suppression unit 15 of the control unit 12 sends a control signal to the audio output unit 10 in response to an input of the noise detection signal.

The audio output unit 10 causes the output level (volume) of the audio which is output from the speaker 2 as mentioned above to be lowered to a predetermined low level or zero, while the block noise is detected in response to the control signal.

Therefore, even when the block noise is generated in the received digital signal, the audio output is suppressed, thereby allowing a user to watch a broadcast program without experiencing an uncomfortable feeling due to popping.

<Operation as Video Recorder>

The television receiver with a video recorder function can record a broadcast program during viewing of the broadcast program which is being received, as is well known, or can receive and record the broadcast program in a state where a program viewing function of the television receiver is turned off. In addition, as is well known, a broadcast program for which recording is desired can also be recorded through reservation setting by causing the reservation unit 14 to function depending on a user's setting.

When the television receiver functions as a video recorder in this manner, the broadcast program received in the tuner unit 5 through the antenna 4 is sent to the recording unit (HDD) 13 and is recorded thereon, as mentioned above.

When a broadcast program is recorded during viewing of the broadcast program which is being received, as mentioned above, the block noise detection unit 11 detects the presence or absence of the block noise, sends the noise detection signal to the control unit 12 at the time of detecting the block noise, and suppresses the audio output level of the program which is being watched.

Along with this, when the television receiver functions as a video recorder, the OSD processing unit 16 of the control unit 12 adds the additional information indicating the block noise is contained in the broadcast program recorded on the recording unit 13, in response to the noise detection signal.

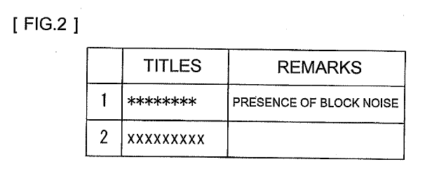

For example, using a list display function of the recorded program included in the recording unit 13, as shown in FIG. 2, information of “presence of block noise” is added to the broadcast program in which the block noise is contained, in a list including titles, remarks or the like of the programs recorded on the recording unit 13.

When the broadcast program recorded on the recording unit 13 is reproduced, the OSD processing unit 16 displays the list of recorded programs on the screen 1, a user trying to reproduce and watch the recorded broadcast program can be informed beforehand that the block noise is contained therein.

In addition, in the embodiment, rebroadcast of a program recorded on the recording unit 13, within which the block noise is included can also be recorded again by causing the reservation unit 14 to function depending on the user's setting.

Information, such as titles and broadcast start and end time of broadcast programs for about a week of which broadcast is scheduled, is contained in an electronic program guide (EPG) which is superimposed on the broadcast programs, and the reservation unit 14 performs a process for causing a rebroadcast to be recorded on the recording unit 13 using the electronic program guide.

That is, the reservation unit 14 retrieves rebroadcast having the same title from the electronic program guide, with respect to the programs to which information of “presence of block noise” is added, on the basis of the list of recorded programs mentioned above, and when the rebroadcast is present, the reservation unit performs a reservation process for recording the rebroadcast program on the recording unit 13.

The recording of the rebroadcast program on the recording unit 13 may be a method of overwriting the same program which is already recorded, or may be a method of separately recording the program without overwriting it. Even in a case of either of the methods, a user can reproduce and watch programs which do not contain the block noise from the recording unit 13.

In the embodiment, although an example is illustrated in which the block noise detection unit 11 is provided at the latter stage of the video decoding unit 7, the block noise detection unit 11 may be provided at the former stage of the video decoding unit 7, or the former stage or the latter stage of the audio decoding unit 9. Even in a case of either of the configurations, as stated above, it is possible to perform an audio mute or recording of a program on the generation of the block noise.

Meanwhile, noise slightly earlier than the audio analog signal may come out in the video analog signal. Therefore, as in the embodiment, it is preferable to provide the block noise detection unit 11 at the latter stage of the video decoding unit 7.

Further, in the embodiment, although an example of the television receiver with a video recorder function is illustrated, it can also be configured as a television receiver or a video recorder. Even in such a configuration, as stated above, it is possible to perform an audio mute or recording of a program on the generation of the block noise.

Meanwhile, in the configuration shown in FIG. 1, when the configuration is configured as the television receiver, it may be configured, for example, except for the recording unit 13 or the reservation unit 14. When the configuration is configured as the video recorder, it may be configured, for example, except for the screen or the speaker 2.

What is claimed is:

1. A digital broadcasting receiver comprising:
a decoding means for decoding a received digital signal containing video and audio;
an audio output means for performing an audio output process on the decoded audio signal;
a detection means for detecting block noise contained in the signal, at a former stage or a latter stage of the decoding means; and
an audio suppression means for lowering an output audio level through the audio output means, in accordance with the detection of the block noise in the detection means.

2. A digital broadcasting receiver comprising:
a demultiplexing means for demultiplexing a received digital signal containing video and audio into a video digital signal and an audio digital signal;
a video decoding means for decoding the video digital signal;
a video output means for performing a video output process on the decoded video signal;
an audio decoding means for decoding the audio digital signal;
an audio output means for performing an audio output process on the decoded audio signal;
a detection means for detecting block noise contained in the signal, at a former stage or a latter stage of the video decoding means, or a former stage or a latter stage of the audio decoding means; and
an audio suppression means for lowering an output audio level through the audio output means, in accordance with the detection of the block noise in the detection means.

3. The digital broadcasting receiver according to claim 1, further comprising:
a recording means for recording the received digital signal; and
an information addition means for adding additional information indicating that the block noise is contained in the received digital signal recorded on the recording means, in accordance with the detection of the block noise in the detection means.

4. The digital broadcasting receiver according to claim 2, further comprising:
a recording means for recording the received digital signal; and
an information addition means for adding additional information indicating that the block noise is contained in the received digital signal recorded on the recording means, in accordance with the detection of the block noise in the detection means.

5. The digital broadcasting receiver according to claim 3, wherein the received digital signal recorded on the recording means is a broadcast program, and
the digital broadcasting receiver further comprises a reservation means for retrieving rebroadcast of a broadcast program in which the block noise is detected by the detection means from broadcast schedule information, and performs a reservation process for recording the rebroadcast program on the recording means.

6. The digital broadcasting receiver according to claim 4, wherein the received digital signal recorded on the recording means is a broadcast program, and
the digital broadcasting receiver further comprises a reservation means for retrieving rebroadcast of a broadcast program in which the block noise is detected by the detection means from broadcast schedule information, and performs a reservation process for recording the rebroadcast program on the recording means.

7. The digital broadcasting receiver according to claim 3, wherein the digital broadcasting receiver is configured as a video recorder, connected to a television receiver, in which video which is output by the video output means is displayed on a screen of the television receiver, and audio which is output by the audio output means is output from a speaker of the television receiver.

8. The digital broadcasting receiver according to claim 4, wherein the digital broadcasting receiver is configured as a video recorder, connected to a television receiver, in which video which is output by the video output means is displayed on a screen of the television receiver, and audio which is output by the audio output means is output from a speaker of the television receiver.

9. The digital broadcasting receiver according to claim 5, wherein the digital broadcasting receiver is configured as a video recorder, connected to a television receiver, in which video which is output by the video output means is displayed on a screen of the television receiver, and audio which is output by the audio output means is output from a speaker of the television receiver.

10. The digital broadcasting receiver according to claim 6, wherein the digital broadcasting receiver is configured as a video recorder, connected to a television receiver, in which video which is output by the video output means is displayed on a screen of the television receiver, and audio which is output by the audio output means is output from a speaker of the television receiver.

11. The digital broadcasting receiver according to claim 2, wherein the digital broadcasting receiver is configured as a television receiver including a screen that displays video which is output by the video output means and a speaker that outputs audio which is output by the audio output means.
